(19) United States
(12) Patent Application Publication
(10) Pub. No.: US 2006/0101573 A1
(43) Pub. Date: May 18, 2006

(54) Jet powered spa water feature

(76) Inventors: Robert T. Hallam, Rancho Santa Fe, CA (US); Timothy P. Pflueger, Escondido, CA (US); Timothy C. Dennison, San Diego, CA (US)

Correspondence Address: FISH & RICHARDSON, PC, P.O. BOX 1022, MINNEAPOLIS, MN, 55440-1022, US

(21) Appl. No.: 10/987,840

(22) Filed: Nov. 12, 2004

(51) Int. Cl. A61H 33/04

(52) U.S. Cl. 4/541.6

(57) ABSTRACT

A water feature for a spa having a water jet is provided by a water feature attachment. The attachment includes a water feature module having at least one water outlet configured to generate a dynamic water feature such as a fountain. The attachment further includes an attachment mechanism connected to the water feature module and configured for detachable connection to the water jet. A light source can be provided to illuminate the water feature.

### BACKGROUND

Water features have become very popular in landscape designs, particularly single-family home landscapes, both for their aesthetic value and property improvement aspect. Companies market various products that allow homeowners to easily add a water feature to their existing landscape design.

To fulfill this market opportunity, the spa/hot tub/pool (referred to generically hereafter as “spa”) industry is currently marketing water features that are built directly into a spa's design. These water features come in a variety of shapes, sizes, and costs, and are of varying complexity. Typical water features include integrated pumps and controls, and often include a fixed water spout head to creates a particular water flow pattern and sound for a particular desired aesthetic. These features cannot be changed or modified by the customer.

Accordingly, each unique water feature design requires a unique system, which leads to a large number of parts and processes to control and service. Additionally, it is difficult, if not impossible, to add a water feature to an existing system that was not originally configured with one. The expenses associated with retrofitting a pump, plumbing, water feature nozzle, lighting, controls and/or control circuitry is cost-prohibitive in most cases.

### SUMMARY

This document discloses a water feature for a spa that has at least one water jet. The water feature is provided by a water feature attachment. The attachment includes a water feature module having at least one water outlet configured to generate a dynamic water feature such as a fountain. The attachment further includes an attachment mechanism connected to the water feature module and configured for detachable connection to the water jet. A light source can be provided to illuminate the water feature.

The water feature attachment can be easily attached and removed from the jet, and positioned and arranged as desired to generate a desired water feature effect. The water feature attachment includes a flexible angle adjuster that is connected between the module and the attachment mechanism, for precise alignment and positioning of the module and which can be safely folded up for storage.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is side perspective view of a water feature attachment.

FIG. 2 is a side perspective view of a water feature attachment in accordance with an alternative embodiment.

FIG. 3 is a top-down view of a water outlet mechanism having a number of nozzles.

FIG. 4 is a perspective view of water nozzles and a lighting source thereof.

Like reference symbols in the various drawings indicate like elements.

### DETAILED DESCRIPTION

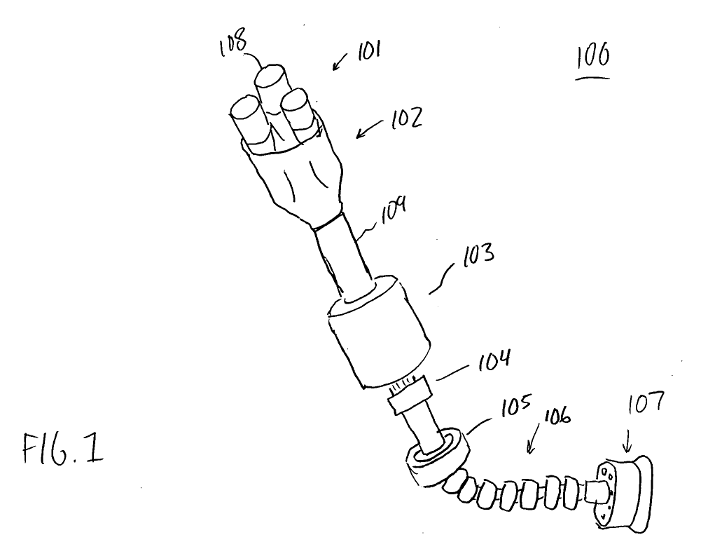

FIG. 1 is a perspective view of a water feature attachment 100 that can be used in a spa with any of a spa's existing jets to provide a water feature such as a fountain. The water feature attachment 100 includes a water feature module 102 with a water inlet and having a head 101. The head 101 includes a water outlet that can be shaped to create unique dynamic water features. The head can be interchangeable. The water feature module 102 may also be configured to create a specific range of pressure for the desired feature effect out of the head 101.

The water inlet of the water feature module 102 is connected to a conduit 109 that receives a flow of water from a jet attachment 107 that is connectable to any sized spa jet or similar water outlet of a spa. The jet attachment 107 may also include a mechanism to meter and/or regulate the speed and/or pressure of a flow of water into the conduit 109. In one operation, a jet fitting in the spa can be popped out and the jet attachment 107 snapped into its place over the jet. In an alternative operation, a spa may be outfitted with a specialized or customized water jet that is closed until the jet interface 107 is attached to it. In yet another operation, the jet attachment 107 can simply snap onto an existing jet fitting in the spa.

The water feature attachment 100 may also include a power and light container 103. The container 103 can include a power source such as a battery, an inductively-coupled power module or a water-powered dynamo, and a lighting source such as lighting circuitry and lights. The lights can be low-voltage light emitting diodes (LEDs) or incandescent lamps. In one exemplary embodiment, the lighting source illuminates the head 101. In an alternative embodiment, the lighting source illuminates the water flowing out of the head 101. In yet another embodiment, both the head 101 and water are illuminated. The lights may be positioned on or below the head 101, or in the container 103.

A vertical adjustment mechanism 104 provides for adjustment and placement of the water feature module 102 in the vertical plane. In a specific embodiment, the water feature attachment 100 includes a stabilizer ring 105 for stabilizing the water feature module 102 in the spa. The water feature attachment 100 also includes an angle adjuster 106. The angle adjuster 106 is configured for flexibly adjusting the water feature module 102 at a specific or desired angle from the direction of the water source jet in the spa. In one embodiment, the angle adjuster 106 includes a number of interconnected knuckles surrounding an internal bendable conduit for allowing the water feature module 102 to be oriented and fixed to any desired angular position.

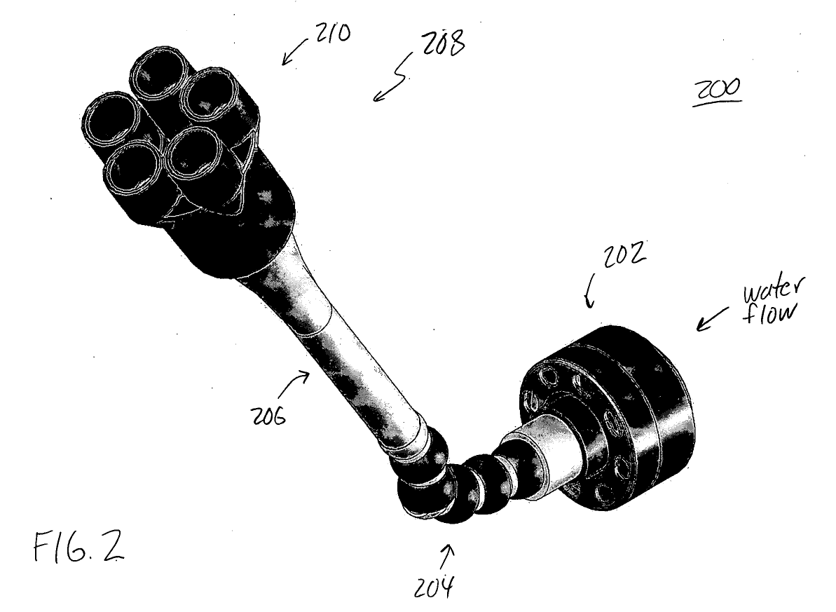

FIG. 2 is a perspective view of a water feature attachment 200 in accordance with an alternative embodiment. The water feature attachment 200 includes a jet attachment mechanism 202 for attaching to a spa water jet. The jet attachment mechanism 202 can be sized and formed for any shape or sized spa jet. The water feature attachment 200 further includes an angle adjuster 204. The angle adjuster 204 can include one or more interconnected joints that allow one or more angles to be provided to the water feature attachment 200 from the spa water jet. The angle adjuster 204 can be configured as a fold-away safety mechanism for ease of storage or movement of the water feature attachment 200.

The water feature attachment 200 further includes a conduit 206 connected to the angle adjuster 204. The conduit 206 can be any size or length, and is preferably sized and shaped to provide a particular water pressure and flow rate. The conduit 206 is connected to a head 208 having one or more nozzles 210. The head 208 can include a number of internal channels for channeling flowing water to the one or more nozzles 208. These channels can be sized or arranged for a specific flow rate.

One embodiment of the water feature may incorporate an interchangeable head. The head can be removed from the water feature module and another installed in its place. This interchangeability allows personalization of the spa by dynamically changing the visual, audible and mood-enhancing effects of the water feature. The interchangeable heads can create shaped water designs of variable heights adding value to the spa, allowing for uses of the spa in addition to a hydrotherapy or relaxation device. The user can select between having or not having a water feature as well as selecting the particular interchangeable head.

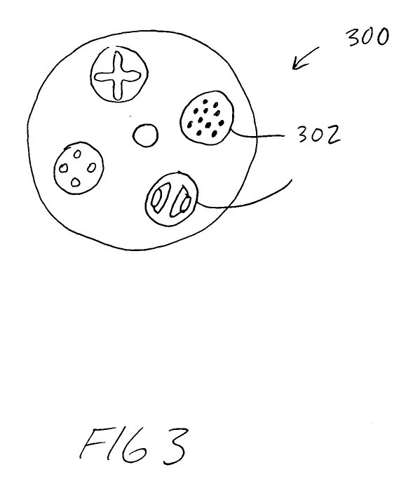

In a specific exemplary embodiment, as shown in FIG. 3, a water outlet 300 can include a number of different nozzles 302. Each nozzle 302 may include a unique pattern of apertures to provide a distinct water flow design pattern or pressure regulator. The water outlet mechanism 300 may include a rotational cap to allow a user to rotate one of the nozzles 302 into a position over a water outlet, and to rotationally interchange the nozzles simply by turning the cap.

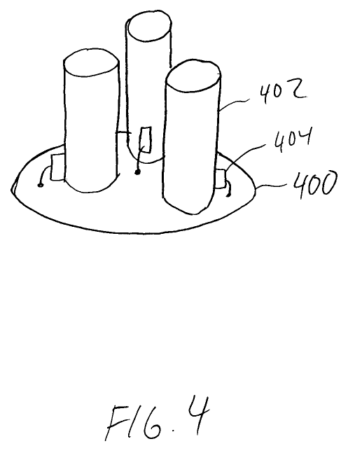

As shown in FIG. 4, the nozzles 402 of the water outlet 400 can be elongated and cylindrical, and be made of a light-carrying material such as acrylic or clear plastic. Lights 404 can be positioned under or next to the nozzles 402 to illuminate both the nozzles 402 and the water flowing through them. The aesthetics offered by the water feature module described herein allows the spa to become a center or focal point of a landscape setting or design. The option to remove the water feature is important because it allows the user to control the usable space, look and feel of the spa.

The water feature module described herein provides manufacturing and servicing cost-savings. The module is easily added to existing spa designs, and there is no need for expensive field or factory-return retrofits. The module is also easy to install and uninstall—a conduit connected to the water feature module is merely inserted into the jet housing without requiring special tools or equipment.

Although a few embodiments have been described in detail above, other modifications are possible. Other embodiments may be within the scope of the following claims.

1. A water feature for a spa having a water jet, the water feature comprising:
a water feature module having at least one water outlet; and
an attachment mechanism connected to the water feature module and configured for detachable connection to the water jet.

2. The water feature in accordance with claim 1, wherein the water outlet includes one or more apertures configured to provide a water flow design pattern.

3. The water feature in accordance with claim 1, wherein the module includes a conduit connected to the attachment mechanism.

4. The water feature in accordance with claim 3, wherein the conduit includes a flexible hose.

5. The water feature in accordance with claim 1, wherein the at least one water outlet includes an interchangeable head.

6. The water feature in accordance with claim 5, wherein the interchangeable head includes a rotatable head mechanism having a plurality of nozzles that are configured to rotate to a position over one of the at least one water outlet.

7. The water feature in accordance with claim 1, further comprising a light coupled with the module.

8. The water feature in accordance with claim 7, wherein the light is positioned next to the water outlet.

9. The water feature in accordance with claim 8, wherein the water outlet includes a transparent nozzle, and wherein the light is positioned to illuminate the transparent nozzle.

10. The water feature in accordance with claim 1, further comprising a power source.

11. A water feature for a spa having at least one water jet, the water feature comprising:
a module having a water inlet and at least one water outlet, the module further including a light source for illuminating water exiting the at least one water outlet; and
an attachment mechanism for detachable connection to the at least one water jet and having an outlet connected to the water inlet of the module.

12. A water feature in accordance with claim 11, wherein the module further includes a stabilization device to stabilize an orientation of the module with respect to a water line in the spa.

13. A water feature in accordance with claim 11, further comprising a power source for powering the light source.

14. A water feature in accordance with claim 13, wherein the power source is a battery.

15. A water feature in accordance with claim 13, wherein the power source is an inductively-coupled power module.

16. A water feature in accordance with claim 13, wherein the power source is a water-powered dynamo.

17. A water feature in accordance with claim 11, wherein the light source includes one or more low voltage LEDs.

18. A water feature in accordance with claim 11, further comprising a conduit connected between the module and the attachment mechanism.

19. A water feature in accordance with claim 18, wherein the conduit is sized and configured to regulate the flow of water therethrough.

20. A water feature in accordance with claim 18, wherein the conduit is sized and adapted to generate a particular water pressure.

21. A water feature in accordance with claim 11, wherein the at least one water outlet includes a head having one or more apertures configured to produce a water flow pattern.

22. A water feature in accordance with claim 21, wherein the head is interchangeable.

23. A water feature in accordance with claim 19, wherein the head is transparent and configured to be illuminated by the light source.
